(19) United States
(12) Patent Application Publication
(10) Pub. No.: US 2015/0242018 A1
(43) Pub. Date: Aug. 27, 2015

(54) SYSTEM AND METHOD FOR RECOGNIZING OBJECTS WITH CONTINUOUS CAPACITANCE SENSING

(71) Applicant: Zheng Shi, Beijing (CN)

(72) Inventor: Zheng Shi, Beijing (CN)

(21) Appl. No.: 14/696,497

(22) Filed: Apr. 27, 2015

Related U.S. Application Data
(63) Continuation of application No. PCT/CN2014/090890, filed on Nov. 12, 2014.
Application No. PCT/CN2014/090890 is a continuation-in-part of application No. PCT/CN2014/080495, filed on Jun. 23, 2014.
Application No. PCT/CN2014/080495 is a continuation-in-part of application No. PCT/CN2014/079892, filed on Jun. 13, 2014.
Application No. PCT/CN2014/079892 is a continuation-in-part of application No. PCT/CN2014/072961, filed on Mar. 6, 2014.
Application No. PCT/CN2014/072961 is a continuation-in-part of application No. PCT/CN2014/071850, filed on Jan. 30, 2014.

(51) Int. Cl. G06F 3/044

(52) U.S. Cl. CPC G06F 3/044; G06F 2203/04101; G06F 2203/04104

(57) ABSTRACT

The present invention discloses a system and method to enable a capacitance sensor to further recognize a capacitive action on an object, after the object has been sensed by the capacitance sensor and switched the sensor to an “on” state. Upon an object having been sensed by a capacitance sensor and having switched the capacitance sensor to an “on” state, the system and method disclosed in the present invention allows the capturing of a capacitive action being performed to the object through a combination of sensor and wireless communication technology. The present invention may be valuable for a variety of education, entertainment and productive applications by providing enhanced human machine interactivity through the manipulation of physical objects.

### CROSS-REFERENCE TO RELATED APPLICATION

This application is a continuation of International Patent Application No. PCT/CN2014/090890, entitled “System And Method For Recognizing Objects With Continuous Capacitance Sensing”, filed on Nov. 12, 2014, which is a continuation in part of International Patent Application No. PCT/CN2014/080495, entitled “System and Method to Recognize an Object's ID, Orientation and Location Relative to an Interactive Surface”, filed on Jun. 23, 2014, which is a continuation in part of International Patent Application No. PCT/CN2014/079892, entitled “System and Method for Identifying an Object's ID and Location Relative to an Interactive Surface”, filed on Jun. 13, 2014, which is a continuation of International Patent Application No. PCT/CN2014/072961, entitled “System and Method for Identifying an Object's ID and Location Relative to an Interactive Board”, filed on Mar. 6, 2014, which is a continuation in part to International Patent Application No. PCT/CN2014/071850, entitled “System and Method for Identifying an Object's ID and Location Relative to an Interactive Board”, filed on Jan. 30, 2014.

The entire disclosures of each of the above applications are incorporated herein by reference.

### TECHNICAL FIELD

The present invention relates to object recognition on an interactive surface, for enhancing the interactivity of an end-user with a computer through manipulation of physical objects, using a combination of capacitive sensor and wireless communication technology.

### BACKGROUND

The recent abundance of inexpensive computer processors has greatly improved games, toys, books, musical instruments and the like. Increasingly, embedded sensors, coupled with processors linked to sensory accessories such as audio and video devices, are used in games to enrich the interactive experience of the players.

Typically, computerized games provide players with a visual display of the game activity through an electronic display system, such as a pixilated flat panel display or a touch screen. However, such displays are not three-dimensional, which prevents the physical interaction inherent in traditional board-based games. For example, a traditional board game may use one or more movable game pieces that players (especially young ones) find more “natural” and easier to interact with. On the other hand, traditional board games often lack the audio and/or visual interaction that computerized games can offer. Therefore, gaming methods that combine computerized technology with physical play will enhance players gaming experience.

Thus, it is desirable to develop a system and method that allows physical objects to be identified and located in a physically bounded environment by means of a computerized system. For example, allowing a computerized system to recognize both the identity of a board game piece and its location on the game board can enhance a player's experience by allowing their physical actions to be recognized and interpreted by the computer system so as to provide real-time feedback to the player by a multitude of sensorial accessories such as video and/or audio outputs.

### SUMMARY OF INVENTION

The present invention discloses a system and method to enable a capacitance sensor to further recognize a capacitive action on an object, after the object has been sensed by the capacitance sensor and switched the sensor to an “on” state.

After a plurality of objects are placed on an interactive surface, either directly or on top of another object that is placed on the interactive surface, a capacitive action is performed to a particular object among a plurality of objects to which no capacitive action has been performed. A capacitive action is an action by an end-user that changes the capacitive property of an object. A capacitive action being performed to a first object may be touching the first object by a finger or a stylus, or may be placing second object on top of the first object. Symmetrically, a capacitive action being performed to a first object may be the removal of the finger touch, or may be the removal of a second object that has been placed on top of the first object. The object may be a button, card, block, sheet, icon, or a figurine.

Upon an object having been sensed by a capacitance sensor and having switched the capacitance sensor to an “on” state, the system and method disclosed in the present invention allows the capturing of a capacitive action being performed to the object through a combination of sensor and wireless communication technology.

The present invention may be valuable for a variety of education, entertainment and productive applications by providing enhanced human-machine interactivity through the manipulation of physical objects.

### BRIEF DESCRIPTION OF THE DRAWINGS

To better illustrate the technical features of the embodiments of the present invention, various embodiments of the present invention will be briefly described in conjunction with the accompanying drawings. It should be obvious that the drawings are but for exemplary embodiments of the present invention, and that a person of ordinary skill in the art may derive additional drawings without deviating from the principles of the present invention.

FIG. 1 is an exemplary schematic diagram for the process flow of capturing a capacitive action after the capacitance sensor has been switched to an “on” state in accordance with an embodiment of the present invention.

FIG. 2 is an exemplary schematic diagram for an interactive surface for identifying an object's ID, location and orientation relative to the interactive surface in accordance with an embodiment of the present invention.

### DETAILED DESCRIPTION OF THE INVENTION

To better illustrate the purpose, technical feature, and advantages of the embodiments of the present invention, various embodiments of the present invention will be further described in conjunction with the accompanying drawings.

While the present invention will be described in connection with various specific embodiments, the invention is not limited to these embodiments. People skilled in the art will recognize that the system and method of the present invention may be used in many other applications.

For example, the notion of “surface” or “interactive surface” is discussed for the sake of simplicity, but the present invention can easily be applicable in three dimensions, whereby objects are placed on the side of or at the bottom of the interactive surface, such as by using magnets to get the objects to stick to a vertical or upside down surface.

In addition, while a specific capacitance sensor array and a specific antenna array design are disclosed in connection with embodiments of the present invention, other array designs can also be used and are within the scope of the present invention.

In addition, while a sensor system making use of capacitive sensing between a capacitance sensor embedded on the interactive surface and capacitive tabs embedded in an object is disclosed in connection with embodiments of the present invention, other sensor technologies such as resistance touch sensors or piezo touch sensor can also be adapted for the purpose of this present invention and are within the scope of the present invention.

In addition, while a touch by a finger is repeatedly used to represent an action that alters the capacitive property of an object, the use of other means, such as a stylus, a electric conductive material, or a material with high dielectric constant, in order to alter the capacitive property of an object are also within the scope of the present invention.

Furthermore, while a specific communication flow between the processor, the RF antenna array, and multiple objects' RFID chips, is disclosed in connection with embodiments of the present invention, the embodiments of the present invention is not limited to any particular process by which the UID of the object is detected by the interactive surface.

Commercially available capacitance sensors, such as a sensor in the SAMD20 series from ATMEL, are manufactured to produce a binary output—the sensor is either “on” or “off”, “touched” or “not touched”, “engaged” or “not engaged”, “activated” or “sleeping”. Creative usages of functionalities offered by the commercially available capacitance sensors, such as dynamic threshold adjustment during runtime, have allowed for more versatile applications to be enabled. However, they still fail to enable the embodiments in this present invention. For example, the SAM D20 Microcontrollers deems a negative capacitance value as an error according to Atmel published literature.

In accordance with one embodiment of the present invention, a commercially available capacitance sensor is enabled to export an indication of the degree of the capacitance sensing signal, instead of a binary outcome. A microcomputer unit is used to import proxy values of changes in capacitance from the integrated circuit of the capacitance sensor, and export these values to a computer program to be analyzed for the nature of the capacitive action that has happened to a particular object.

In accordance with one embodiment of the present invention, an object is embedded with a capacitance tab made of high dielectric constant material that is capable of triggering a capacitive action. Upon the object being placed on the capacitance sensor, the capacitance sensor is switched to an “on”, or “touched”, or “engaged”, or “activated” state, by the capacitance tab embedded in the object. Furthermore, after the object is placed on the capacitance sensor (and causing the capacitance sensor to switch to an “on” state) and upon a finger-touching action being performed to the object, the capacitance sensor senses the change in capacitance by the finger touch and sends the information pertaining to this change in capacitance to a processor that is operatively linked to the capacitance sensor. This finger-touching action acted upon the object that has already been placed upon a capacitance sensor is thereby captured and recorded.

In accordance with one embodiment of the present invention, an object is embedded with an RFID tag containing a unique identification code (UID). Upon the processor receiving a signal representing a change in capacitance from a capacitive action, the processor is configured to direct an RFID reader to read the UID of the object.

In accordance with one embodiment of the present invention, an object is embedded with a capacitance tab made of high electric constant material that is capable of triggering a capacitive action and an RFID tag with the unique ID of the object encoded. Upon the object being placed on the capacitance sensor, the capacitance sensor is switched to an “on”, or “touched”, or “engaged” state, by the capacitance tab. Furthermore, once a finger-touching action has been performed on the object that is placed on the capacitance sensor (that has been switched to “on” state), the capacitance sensor senses the change in capacitance by the finger touch, and sends the change in capacitance to a processor that is operatively linked to the capacitance sensor. The processor further determines which object has been touched by instructing an RF antenna and reader to read the UID of the object.

In accordance with another embodiment of the present invention, an array of capacitance sensors and an array of RF antennas are superimposed on each other within a surface to form an interactive surface. Upon a capacitive action as sensed by one or more capacitance sensors, the processor is configured to activate the RF antenna assigned to the one or more capacitance sensors that have experienced a change in capacitance in order to determine the UID of an object, and to derive the location, UID and orientation of the object, and the entity responsible for the capacitive action.

In accordance with one embodiment of the present invention, values of capacitance and capacitance changes as sensed by the capacitance sensor are pre-measured and pre-calibrated for each object among the plurality of objects under an extensive set of scenarios including being in a “standalone” mode, being touched by a finger and being superimposed on another object or vice versa, with such values processed to generate a set of calibration curves and the calibration curves stored in a computer memory that is operatively linked to the processor. Upon a capacitive action, the processor is configured to determine the entity responsible for the capacitive action based on capacitance values received from the capacitance sensor and the calibration curves stored in the computer memory.

The present invention may be better understood and its objects and advantages will become more apparent to those skilled in the art by reference to the accompanying drawings.

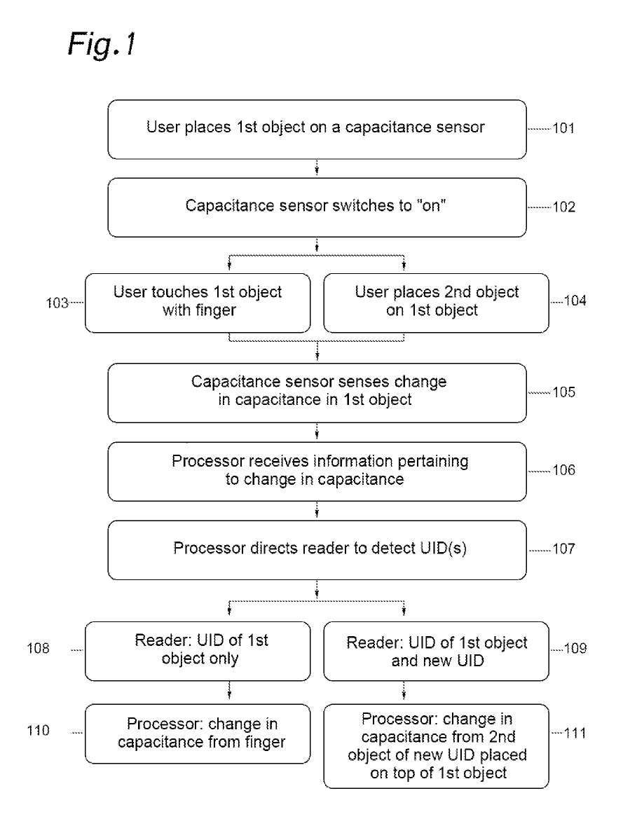

FIG. 1 is an exemplary schematic diagram for the process flow of capturing a capacitive action after the capacitance sensor has been switched to an “on” state in accordance with an embodiment of the present invention. The first step (101) involves having a user place a 1st object upon the interactive surface. This causes the interactive sensor(s) in contact or in close proximity with the object's capacitance tab to switch to an “on” state (102). As this point, a user may either touch the surface of the 1st object (103) or place a 2nd object on top of the 1st object (104). This further leads the same capacitance sensor(s) to detect another change in capacitance (105). The information pertaining to this new change in capacitance is sent to the processor (106) which subsequently directs the RF antenna assigned to the interactive surface's capacitance sensor(s) that has experienced the change in capacitance to wirelessly communicate with an object(s)'s RFID within its broadcasting area and determine the object(s) UID(s) (107). In the case that the RF antenna only reads the UID of the 1st object (108), then the processor determines that the change in capacitance is attributable to a user touch (110). On the other hand, if the RF antenna reads another UID apart from that of the 1st object (109), then the processor determines that the new change in capacitance is attributable to a 2nd object placed on top of the 1st object (111).

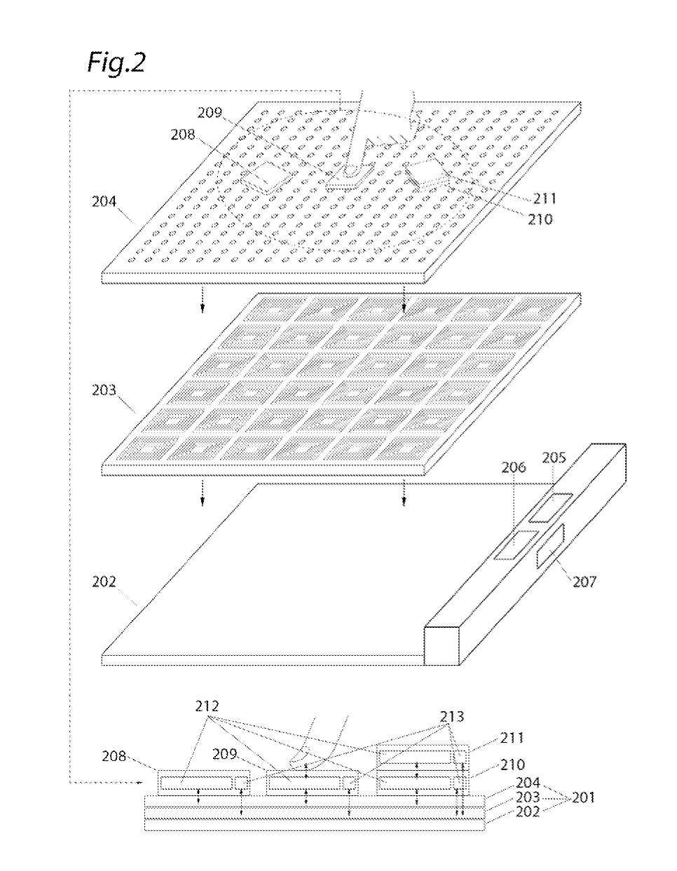

FIG. 2 is an exemplary schematic drawing of the system of the present invention in accordance to one embodiment of the present invention. The interactive surface 201 consists of three superimposed layers and a peripheral unit. The first layer 202 consists of the substrate or base of the interactive surface. The second layer consists of an RF antenna array 203 whose function is to wirelessly determine the UID of an object's RFID. The third layer consists of an array of capacitance sensors 204 whose purpose is to detect the location and orientation of objects placed upon the interactive surface 201. In the particular embodiment described in FIG. 1, each capacitance sensor is assigned to the RF antenna closest to it. Finally, the peripheral unit consists of the interactive surface's 201 processor 205, memory unit 206 and power source 207.

FIG. 2 further shows a number of objects placed upon the surface of the interactive surface 201. One object 208 has been placed alone, another object 209 is further being touched by the finger of a user and finally two objects 210, 211 have been placed on the interactive surface 201 with one placed on top of the other. Each object is embedded with both a capacitance tab 212 and an RFID tag 213.

The process of the present invention will better be understood by describing how three different scenarios function within the premise of the present invention.

In the first scenario, an object 208 embedded with a capacitance tab 212 has been place upon the interactive surface 201, causing the interactive surface's 201 capacitance sensors 204 to switch into an “on” state. This causes the processor 205 to direct the RF antenna assigned to these capacitance sensors 204 to read the UID of the object's 208 RFID tag 213. Once the processor 205 has determined the location, orientation and UID of the object 208 it stores this information into its memory 206.

In the second scenario, once the an object 209 is placed on the interactive surface 201 and its location, orientation and UID is determined by the processor 205 using the same process as described in the first scenario, a user then proceeds to touch the object with a finger. Doing so causes the those capacitance sensor(s) 204 under object 209 that have already detected the object 209 to sense another change in capacitance, and send such change in capacitance to the processor 205. This causes the processor 205 to direct once again the RF antenna assigned to these capacitance sensors 204 under object 209 to read the UID of any object's RFID tag 213 placed in within the RF antenna's detection area. In this case, only the original object 209's UID is read and the processor 205 determines this new change in capacitance is attributable to a user touch on the object 209.

In the third scenario, once a first object's 210 location, orientation and UID has been determined by the processor 205 through the same process described in the first scenario, the user places a second object 211 on top of the first object 210. Similar to the second scenario, doing so causes the those capacitance sensor(s) 204 under the first object 210 that have already detected the first object 210 to sense another change in capacitance, and send information pertaining to such change in capacitance to the processor 205. This causes the processor 205 to direct once again the RF antenna assigned to these capacitance sensors 204 under object 210 to read the UID of any object's RFID tag 213 placed in within the RF antenna's detection area. In this case the processor 205 will read two UIDs, one corresponding to the original first object 210 and a new UID corresponding to the second object 211. In this case, the processor determines that the change in capacitance must be attributable to a second object 211 that has been placed on top of the first object 210. As before, the processor 205 proceeds to store this information into the memory unit 206.

1. A system for capturing a capacitive action being performed to an object, comprising
a plurality of objects, each embedded with a capacitance tab and a unique identification code (UID),
a capacitance sensor that is operatively linked to a processor,
a reader whose detection range encompasses the detection range of the capacitance sensor, and is operatively linked to the processor,
wherein, after a first object has been placed on the capacitance sensor and thereby the capacitance sensor has switched to an “on” state from an “off” state, and further upon a capacitive action being performed to the first object, the capacitance sensor senses a change in capacitance of the first object, and the processor is configured to receive a signal representing the change in capacitance from the capacitance sensor and direct the reader to detect UID.

2. The system in claim 1, wherein the capacitive action being performed to an object is selected from a group comprising
touching the object by a finger, and removing from the object the finger touch,
placing a finger in proximity with the object, and removing the finger from the proximity of the object,
touching the object with a physical stylus, and removing the physical stylus from the object,
touching the object with a device capable of causing a change in capacitive property of the object, and removing such device from the object,
approaching the object with a device capable of causing a change in capacitive property of the object, and moving such device away from the object.

3. The system in claim 1, wherein the capacitive action being performed is placing a second object on top of the first object, the reader detects the UID of the first object and a new UID, and the processor is configured to assign the new UID to the second object.

4. The system in claim 3, wherein a third object is placed on top of the second object, the reader detects the UID of the first object, the UID of the second object, and a new UID, and the processor is configured to assign the new UID to the third object.

5. The system in claim 1, wherein the UID is encoded with an RFID tag, and the reader is an RF antenna and reader module.

6. The system in claim 1, further comprising an array of capacitance sensors, and an array of readers, embedded within an interactive surface, wherein, upon a plurality of objects having been placed on the interactive surface, the processor is configured to capture a capacitive action that is happening to any one object.

7. The system in claim 1, wherein an object is selected from a group comprising a button, card, block, sheet, icon, or figurine.

8. A system for capturing a capacitive action being performed to an object, comprising
a plurality of objects, each embedded with a capacitance tab,
a capacitance sensor that is operatively linked to a processor,
wherein, after a first object has been placed on the capacitance sensor and thereby the capacitance sensor has switched to an “on” state from an “off” state, and further upon a capacitive action being performed to the first object, the capacitance sensor senses a change in capacitance of the first object, and the processor is configured to receive a signal representing the change in capacitance from the capacitance sensor.

9. The system in claim 8, further comprising a memory that is operatively linked to the processor and stores a set of calibration curves regarding an object and values of capacitance as the object being sensed by the capacitance sensor, wherein, the processor is configured to determine the entity responsible for the capacitive action based on capacitance values received from the capacitance sensor and calibration curves.

10. A method for capturing a capacitive action being performed to an object, comprising
placing a first object on a capacitance sensor to switch the capacitive sensor to an “on” state from an “off” state, wherein the first object is among a plurality of objects, each embedded with a capacitance tab and a unique identification code (UID),
performing a capacitive action to the first object,
sensing a change in capacitance of the first object by the capacitance sensor that is operatively linked to the processor,
receiving a signal representing the change in capacitance from the capacitance sensor by a processor that is operatively linked to the capacitance sensor,
directing, by the processor, a reader, that is operatively linked to the processor and whose detection range encompasses the detection range of the capacitance sensor, to detect UID.

11. The method in claim 10, wherein the capacitive action being performed to an object is selected from a group comprising
touching the object by a finger, and removing from the object the finger touch,
placing a finger in proximity with the object, and removing the finger from the proximity of the object,
touching the object with a physical stylus, and removing the physical stylus from the object,
touching the object with a device capable of causing a change in capacitive property of the object, and removing such device from the object,
approaching the object with a device capable of causing a change in capacitive property of the object, and moving such device away from the object.

12. The method in claim 10, wherein the capacitive action being performed is placing a second object on top of the first object, and the reader detects the UID of the first object and a new UID, and further comprising, assigning the new UID to the second object by the processor.

13. The method of claim 12, further comprising, placing a third object on top of the second object, detecting the UID of the first object, the UID of the second object, and a new UID by the reader, and assigning the new UID to the third object.

14. The method in claim 10, wherein the UID is encoded with an RFID tag, and the reader is an RF antenna and reader module.

15. The method in claim 10, further comprising an array of capacitance sensors, and an array of readers, embedded within an interactive surface, wherein, upon a plurality of objects having been placed on the interactive surface, the processor is configured to capture a capacitive action that is happening to any one object.

16. The method in claim 10, wherein an object is selected from a group comprising a button, card, block, sheet, icon, or figurine.

17. A method for capturing a capacitive action being performed to an object, comprising
placing a first object on a capacitance sensor to switch the capacitive sensor to an “on” state from an “off” state, wherein the first object is among a plurality of objects, each embedded with a capacitance tab,
performing a capacitive action to the first object,
sensing a change in capacitance of the first object by the capacitance sensor that is operatively linked to the processor,
receiving a signal representing the change in capacitance from the capacitance sensor by a processor that is operatively linked to the capacitance sensor.

18. The method in claim 17, further comprising, determining the entity responsible for the capacitive action from the change in capacitance received from the capacitance sensor, based on a set of calibration curves that are stored in a memory that is operatively linked to the processor.
